(19) United States
(12) Patent Application Publication
(10) Pub. No.: US 2009/0219932 A1
(43) Pub. Date: Sep. 3, 2009

(54) MULTI-STREAM DATA TRANSPORT AND METHODS OF USE

(75) Inventor: Osamu KOBAYASHI, Los Altos, CA (US)

Correspondence Address: STMICROELECTRONICS, INC., MAIL STATION 2346 , 1310 ELECTRONICS DRIVE, CARROLLTON, TX, 75006, US

(73) Assignee: STMICROELECTRONICS, INC., Carrollton, TX (US)

(21) Appl. No.: 12/365,678

(22) Filed: Feb. 4, 2009

Related U.S. Application Data
(60) Provisional application No. 61/026,065, filed on Feb. 4, 2008.

(51) Int. Cl. H04L 12/56

(52) U.S. Cl. 370/389

(57) ABSTRACT

A method of data transmission in a multimedia network. The network having a source coupled to a sink by a linking unit capable of supporting at least one virtual channel. The method receiving a plurality of source data streams in accordance with a native stream rate and packetizing each stream in accordance with its native rate into a stream of payloads, each associated with its respective source stream. Payloads from each source stream are inserted into a transfer unit such that each transfer unit contains one payload from each stream. A stream of transfer units are transmitted through a virtual channel of the linking unit, thereby transmitting more than one source stream in the same virtual channel.

### CROSS REFERENCE TO RELATED APPLICATIONS

This patent application takes priority under 35 U.S.C. 119(e) to (i) U.S. Provisional Patent Application No. 61/026,065 (Attorney Docket No. GENSP203P) filed on Feb. 4, 2008, entitled “MULTIPLE STREAM DISPLAY” by Kobayashi, which is hereby incorporated by reference herein in its entirety. This application is also related to the following U.S. patents and co-pending U.S. patent applications, each of which are incorporated by reference, (i) U.S. Pat. No. 7,424,558, filed Dec. 2, 2003 and issued Sep. 9, 2008, entitled “METHOD OF ADAPTIVELY CONNECTING A VIDEO SOURCE AND A VIDEO DISPLAY” naming Kobayashi as inventor; (ii) U.S. Pat. No. 7,068,686, filed Dec. 2, 2003 and issued Jun. 27, 2006, entitled “METHOD AND APPARATUS FOR EFFICIENT TRANSMISSION OF MULTIMEDIA DATA PACKETS” naming Kobayashi as inventor; (iii) U.S. patent application Ser. No. 10/726,440, (Attorney Docket No.: GENSP105), entitled “METHOD OF OPTIMIZING MULTIMEDIA PACKET TRANSMISSION RATE”, naming Kobayashi as inventor; (iv) U.S. Pat. No. 7,088,741, filed Dec. 2, 2003 and issued Aug. 8, 2006, entitled “USING AN AUXILIARY CHANNEL FOR VIDEO MONITOR TRAINING”, naming Kobayashi as inventor; (v) U.S. patent application Ser. No. 10/726,350 (Attorney Docket No.: GENSP106), entitled “TECHNIQUES FOR REDUCING MULTIMEDIA DATA PACKET OVERHEAD”, naming Kobayashi as inventor; (vi) U.S. patent application Ser. No. 10/726,362 (Attorney Docket No.: GENSP107), entitled “PACKET BASED CLOSED LOOP VIDEO DISPLAY INTERFACE WITH PERIODIC STATUS CHECKS”, naming Kobayashi as inventor; (vii) U.S. patent application Ser. No. 10/726,895 (Attorney Docket No.: GENSP108), entitled “MINIMIZING BUFFER REQUIREMENTS IN A DIGITAL VIDEO SYSTEM”, naming Kobayashi as inventor; and (viii) U.S. patent application Ser. No. 10/726,441 (Attorney Docket No.: GENSP109), entitled “VIDEO INTERFACE ARRANGED TO PROVIDE PIXEL DATA INDEPENDENT OF A LINK CHARACTER CLOCK”, naming Kobayashi as inventor; (ix) U.S. Pat. No. 6,992,987, filed Dec. 2, 2003 and issued Aug. 8, 2006, entitled “ENUMERATION METHOD FOR THE LINK CLOCK RATE AND THE PIXEL/AUDIO CLOCK RATE”, naming Kobayashi as inventor, and (x) U.S. patent application Ser. No. 10/726,794 (Attorney Docket No.: GENSP013), entitled “PACKET BASED VIDEO DISPLAY INTERFACE AND METHODS OF USE THEREOF” naming Kobayashi as inventor, and (xi) U.S. patent application Ser. No. 10/909,085 (Attorney Docket No.: GENSP127), entitled “PACKET BASED STREAM TRANSPORT SCHEDULER AND METHODS OF USE THEREOF” naming Kobayashi as inventor.

### FIELD OF THE INVENTION

The invention relates to data transmission in multimedia networks. More specifically, the invention describes a multimedia device network and method of stream packet delivery with a data packet stream scheduler and methods of use thereof.

### BACKGROUND OF THE INVENTION

Raster scan video transport protocols were originally developed for use with cathode ray tube (CRT) based display systems that must take into account the fact that an electron gun(s) is used to physically “paint” the displayed image one line at a time. For example, a standard definition (VGA) video image is formed of an active region that nominally includes 480 active display lines each of which is formed of 640 pixels (i.e., 640×480 resolution). In addition to the active region, however, a blanking region that is not displayed but nonetheless is included in the video signal since it represents that amount of time that is required for both horizontal and vertical retrace. For example, each frame of a VGA image (i.e., one full frame being 480 lines of 640 pixels each) requires approximately 160 pixel clocks per line for horizontal retrace and a period of time equal to approximately 45 line periods for vertical retrace. In this way (assuming one pixel per pixel clock) the video signal required to transport the video data necessary to display the VGA image must be on the order to 800 pixel clocks. Thus, a blanking cycle of 800 pixel clocks is used (640 active pixel clocks+160 blanking pixel clocks). Therefore, the transport efficiency (as defined as the bandwidth of the displayable data over the total data stream bandwidth) is on the order of 80% (i.e., 640/800).

More recently, as the resolution of CRTs has increased in order to accommodate HDTV and other high end graphics applications, the efficiency of raster scan video transport protocols have been increased to approximately 90% by requiring that the horizontal retrace be limited to 160 pixel clocks (thereby reducing the associated blanking period). For example, given a UVGA image (i.e., 1600×1200), the transport efficiency is approximately 90% when the horizontal retrace is maintained at 160 pixel clocks (1600/(1600+160)) Although raster scan video transfer protocols are efficient (on the order of 90%) and do not require large buffers, they are, however, inflexible in that it is essentially capable of only displaying data as it is rendered.

In addition to raster scan video transport protocols, the emergence of digital video based systems has created the need for digital video transport protocols. One such digital video transport protocol referred to I.E.E.E. 1394, or FireWire™ is based upon isochronous packet transport that relies upon a large buffer (on the order of 60Kb) in order to guarantee a uniform bit rate and maintain synchronicity between multiple data streams (such as a video stream and an associated soundtrack in the form of an audio stream). Although isochronous packet transfer protocols are inherently flexible (due to their packet based nature), the large buffer requirements can be very costly.

Thus, it is desirable to create a data stream transport protocol that has the efficiency (in terms of both transport efficiency and memory resource utilization) of the raster scan transfer protocol and the flexibility of the isochronous packet transfer protocol. Additionally, it is desirable to configure a data transfer methodology that enables more than one source data stream to be transferred over a virtual channel of a link configured with a uni-directional main link and a bi-directional auxiliary link where the main link can be configured to support a plurality of virtual channels for data transmission. This will enable the source transport for each link to extend beyond the current four source stream maximum. It would be advantageous to reduce the space occupied by headers to increase the data content for each package.

### SUMMARY OF THE INVENTION

A method of the invention is directed to transmitting multimedia data from a multimedia source device to a sink device. The sink and source coupled using a linking unit configured having at least one data channel. The channel configured to transmit data at a channel bit rate. In such environment the method includes providing the data link with a virtual data channel. A plurality of source data streams are provided for transmission with each stream provided at native stream data bit rate. A stream of transfer units is configured for transmission through the virtual channel of the linking unit. The nature of the formatting is such that the plurality of data streams are configured into a stream of transfer units capable of transmitting the plurality of source data streams to the sink using only a single virtual channel. Further, attribute information concerning the source data streams and the transfer units is transmitted to the receiver. Then the stream of the transfer units is transmitted at the channel bit rate using said data channel. Related embodiments include the receipt and reconstitution of the source data streams at the receiver.

Another embodiment involves a packet based display interface arranged to couple a multimedia source device to a multimedia sink device. The network including a transmitter unit coupled with the source device. A receiver unit coupled to the sink device. And a linking unit that couples the transmitter with the receiver unit. The link configured to support data transmission using at least one virtual channel. Each channel carrying a stream of transfer units at a channel data bit rate. The transfer units having a predetermined size and arranged to a schedule cycle marker and at least one of a payload space and filler portion. A payload space being allotted for each source data stream and sized in accordance to its native data rate. Wherein the linking unit also transmits data configuration attributes concerning the transfer units to the receiver unit. The interface including a multi-stream scheduler coupled to the linking unit and arranged to schedule data from the plurality of multimedia source data streams for transport through the virtual channel of the linking unit. The scheduler configured to: group data of each source data stream into associated payloads of appropriate size, populate the payload spaces of each transfer unit with at least one of a payload from the appropriate source stream or other symbols, produce source attribute data concerning the transfer units, transmit source attribute data from source to sink using the linking unit, and transmit the stream of the transfer units from the source to the sink at the channel bit rate. In a further embodiment, the scheduler populates the remaining filler portion of transfer unit with space holders to fill the transfer unit. The scheduler can also be configured to dynamically added or subtract source streams from the transfer units.

In another embodiment, a computer program product is disclosed for use in a multimedia network. The program including computer code for providing a plurality of source data streams, each having a stream of associated source data packets with a native stream bit rate. Code for formatting a stream of transfer units such that a plurality of data streams can be transmitted in a single virtual channel in a data link of the network. Code for transmitting attribute information concerning the source data streams and the transfer units to the receiver. Computer code for transmitting the stream of the transfer units using said data channel from the source to the sink at the channel bit rate.

In another embodiment, a data structure for use in a multimedia network is disclosed. The network having a multimedia source device coupled with multimedia sink device using a linking unit configured with at least one data channel for transmitting data at a channel bit rate. That data structure being a data transfer unit having a predetermined length, a schedule cycle marker symbol that delineates successive transfer units in the stream, a plurality of defined payload spaces, and a filler portion. The payload spaces including one for each source data stream to be transmitted using the transfer unit such that the size of the payload space is associated with the native stream rate for each source data stream. The filler portion arranged so that it occupies a portion of the transfer unit not occupied by the schedule cycle marker symbol and not occupied by the payload spaces.

### BRIEF DESCRIPTION OF THE DRAWINGS

FIG. 1 shows a generalized representation of a multi-stream transfer system.

FIG. 2 illustrates a video interface system that is used to connect a video source and a video display unit in accordance with aspects of the invention.

FIG. 3 schematically depicts source data streams multiplexed together and transmitted through a single virtual channel using a multi-stream transfer unit in accordance with the principles of the invention.

FIG. 4(a) schematically depicts the blanking cycles of three source data streams that will be multiplexed together in the same transfer unit in accordance with the principles of the invention.

FIG. 4(b) schematically depicts the how a blanking cycles is tracked through a payload associated with a transfer unit in accordance with the principles of the invention.

FIG. 5 schematically depicts the link line boundaries and link frame boundaries and their configuration and marking in transfer units in accordance with the principles of the invention.

FIG. 6 is a flow diagram illustrating a method embodiment for transmitting multiple streams of source data through a single virtual channel of a link device in accordance with the principles of the invention.

FIG. 7 is a flow diagram illustrating a method embodiment for adding data streams from a transfer unit in a virtual channel of a link device in accordance with the principles of the invention.

FIG. 8 is a diagram illustrating number of transfer units and a stream deletion process in accordance with the principles of the invention.

FIG. 9 is a flow diagram illustrating a method embodiment for deleting data streams from a transfer unit in a virtual channel of a link device in accordance with the principles of the invention.

FIG. 10 illustrates a logical layering of the system in accordance with an embodiment of the invention.

FIG. 12 illustrates a multimedia system employed to implement the invention.

### DETAILED DESCRIPTION OF SELECTED EMBODIMENTS

Reference will now be made in detail to a particular embodiment of the invention an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

The invention will now be described in terms of a video display system having a video source coupled to a video sink, or receiver, by way of a packet based digital interface. The receiver unit is coupled to the source by way of a data, or main link, and an associated auxiliary link can be used. Data can be transmitted from the source, or transmitter, to the sink, or receiver using a stream of data transfer units transmitted through a single channel of the main link. For example, a transmitter unit, coupled to the source device, receives any number of packetized video data streams from a set of sources. Each stream having associated stream attributes. In terms of the video system under discussion, such attributes can include video format, color depth, etc. The many streams can be configured into payloads. Each payload containing a number of packets from the associated video stream. Advantageously, embodiments of the invention can combine the payloads of many different streams together into a common data structure that can be transmitted as a stream through a single virtual channel of linking device. Such data structure is defined herein as a transfer unit. As indicated, a stream of transfer units can be transported to a receiver and associated sink device using a single channel of the link. Thus, many data streams can be transmitted for each channel. Moreover, because more than one channel can be employed by a linking unit, many more streams can be transferred per linking unit than are known in the prior art.

Another particular advantage of the transport methodologies discussed herein is that the data to header ratio is extremely high. This is accomplished by stripping the header information down to the absolute minimum and then transmitting all of the associated attribute data separate from the data. One example takes advantage of linking device having a data main link and an associated auxiliary link. In such a linking device, the auxiliary line can transfer the stream attribute data from the source to the receiver prior to the transmission of the data packets by way of the main link. In another embodiment, the data attribute information can be sent over the main link in a manner that does not decrease the data rate of the source data. One approach takes advantage of the fact that the transfer units are transmitted in a constant stream, whether in the active or blanking portions of a source AV blanking cycle. When the transfer units are transmitted during the blanking period of the blanking cycles they do not carry audio video (AV) data. Aspects of the invention take advantage of these “blank” portions to send data attribute information. Thus, not using up data bandwidth over the main link. These approaches will all be discussed in greater detail in the paragraphs that follow.

In such approaches, packet headers with packet attribute information are not needed. The format of the stream of transfer units is defined and set and then forwarded to the receiver in an attribute packet before the AV data is sent. This attribute data enables the data to be extracted and correctly reconstructed into the appropriate streams at the receiver and forwarded to the appropriate destination. This attribute data is used to identify which data stream a payload is associated with (e.g., a stream ID or other such identifier) as well all the other needed attribute information required to characterize the data and decode each transfer unit. In this way packet overhead is almost completely eliminated preserving main link bandwidth for multimedia content, such as video and audio data providing an efficient packet transport mechanism.

In order to co-ordinate the transmission of the data in the main link, a transport stream scheduler provides for a flexible and efficient system, method, and apparatus for packaging and scheduling packets from a number of different source data streams into transfer units which can be transmitted over a single virtual channel of a data link. Additionally, a scheduler can be used to send stream attribute data from a source to a sink separate from the multimedia data from the source.

In embodiments of the invention, a data transport link (including uni-directional main link and a bi-directional auxiliary link where the main link can be configured to support a plurality of virtual channels for data transmission) is used to transmit data streams. Each link can be configured to transmit data in 1, 2, or 4 virtual channels. In this embodiment each channel can transmit a stream of transfer units where the transfer unit supports data transport of several source data streams. A transfer unit is a fixed size data transmission unit configured to transport several different payloads from several different source streams in a single transport unit. The size can be any size, however, the applicants have found that there are advantages in using transfer units that are 32 or 64 symbols long. This disclosure will discuss the invention in the context of a 64 symbol embodiment, but it is not limited to such. In use, the transfer units are generally uniform in size and include a Schedule Cycle Marker, a filler portion filled with dummy symbols and any from zero to a plurality of payloads.

In a ANSI 8b/10b encoding scheme, the Schedule Cycle Marker (SCM) symbol is a special control symbol that delineates each transfer unit from the next transfer unit in a stream of transfer units. Additionally, the transfer units can include zero, one, or more data payloads each comprising a set of data packets received from an associated source data stream. The size of these payloads is determined by the relation between data rate of the source data stream and the data rate for the particular data channel of the data link (typically, the channel bid rate is some fraction of the link bit rate). In an example link, each channel (1-4 possible channels) can transmit data at a rate up to 2.7 Gb/s (gigabits per second). In this example, the channel at issue is set to transmit at a channel bit rate of 2.56 Gb/s and the channel is configured to transport three source streams. Also, three data streams are introduced at three different example data rates. These data streams are packetized as data payloads that are apportioned to each transfer unit in accord with their own native rates using the following relation. Each payload is allotted a number of symbols in accordance with a relation of the native stream rate to the channel bit rate. Accordingly, a particular payload (i) has a payload size PSᵢ that is related to the transfer unit size (here 64 symbols) in accordance with ratio of stream bit rate to the channel bit rate (which characterizes the rate at which transfer units are transmitted through the channel in question).

In this way, a payload size is determined by the relative bit rate of the data stream compared to a channel bandwidth. For example, for a 64 symbol transfer unit, and the channel bit rate CBR of 2.56 Gb/s Table 1 shows representative packet sizes corresponding to selected stream bit rates. The inventors note that the number of symbols for each payload is typically rounded up.

TABLE 1

| | Channel | Stream | |
|---|---|---|---|
| Stream # | Bit Rate (CBR) | Bit Rate (SBR) | Payload Size (PS) |
| Stream 1 | 2.56 Gbps | 1.28 Gbps | 32 link symbols |
| Stream 2 | 2.56 Gbps | 0.64 Gbps | 16 link symbols |
| Stream 3 | 2.56 Gbps | 0.32 Gbps | 8 link symbols |

Thus, each transfer unit in the channel at issue includes 64 symbols arranged as follows. The first symbol is the SCM which is inserted to delineate each transfer unit. This is the only “header” required. It is followed by a first payload space with a size of 32 symbols which will be populated by a payload data packet comprising 32 symbols from stream 1. Then 16 symbols of a second payload space which will be populated by a data packet comprising 16 symbols from stream 2. Then 8 symbols of a third payload space which will be populated by a data packet comprising 8 symbols from stream 3. This comprises 57 symbols out of the 64 available in the transfer unit. The remaining seven symbols define a filler portion filled with dummy markers or non-data symbols. Each transfer unit in the channel stream is configured like this and remains so until a stream ends or is removed or, alternatively, streams are added. In such cases, the payload positions and filler portions are adjusted, new attribute data is sent to the receiver, and the new transfer units begin operation.

A multi-stream scheduler time division multiplexes (at the transmitter) the multiple source streams into transfer units and de-multiplexes (at the receiver) the payloads of the multiple streams into a set of reconstructed data streams that correspond to the original streams at the transmitter. In the described embodiment, the transfer unit is sized in accordance with a set scheme. For example, as indicated, a fixed size (e.g., 64 symbols) transfer unit is commonly used to transport payload in the channel of the link. Prior to commencing the data stream transport, the transmitter notifies the receiver of stream attributes such as in the case of video data, color format and depth, geometry as well as the packet size associated with each data stream. Additionally, the message contains source attribute information concerning the packaging format of the transfer unit, stream ID, payload size, etc. With this information, the transmitter is able to decode the information transmitted in the transfer units. In the prior art, this information is transmitted as part of the header of each packet. In contrast, the present invention communicates this information separately. By separately communicating the attribute data, the overhead of the transmitted data is reduced to almost nothing. Essentially, the only overhead is the SCM, which in one implementation is one symbol in a 64 symbol transfer unit. This is a non-data overhead of less than 2% resulting in extraordinary data transmission efficiency.

In order to provide a further basis for the discussion of aspects of the invention, one example of a suitable digital video system is described well suited for implementation of the invention. It should be pointed out that many other such system implementations can be used. Some of which are well described

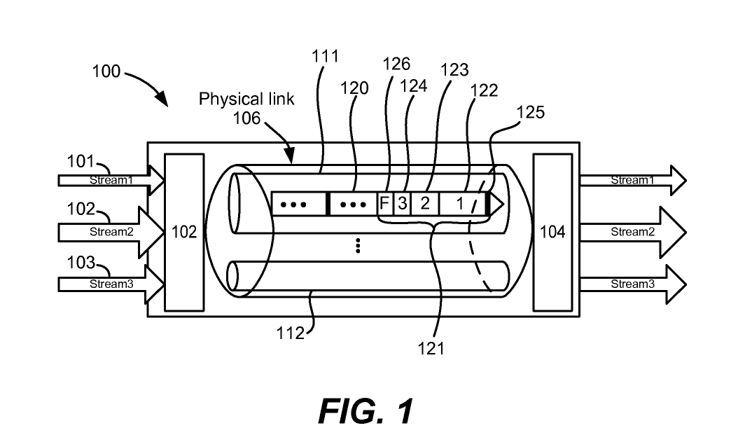

Accordingly, FIG. 1 shows a generalized representation of a digital video display interface 100 in accordance with a number of embodiments of the invention. The interface 100 includes a transmitter 102 and a receiver 104 coupled with a physical link 106 (also referred to as a pipe). In the described embodiment, a number of data streams 101-103 are received at the transmitter 102, typically from a multimedia source (not shown in this view). In this depiction it is shown, that in accord with the a data transport link having a uni-directional main link and a bi-directional auxiliary link, the main link can be configured to support a plurality of virtual channels for data transmission. In such a format, a plurality of virtual channels 111-112 are transmitted using the link 106. One, two, or four such channels can be used. Each such channel capable of transmitting a stream of transfer units 120. Advantageously, the depicted embodiment does not require a clock line or clock signals.

Typically, the transmitter receives one or more data streams 101-103 from a multimedia source (for example an audio-video (AV) source) for transmission to a multi-media sink device (or a branch device). The system 100 multiplexes data from the source data streams 101-103 into data payloads associated with the source data streams. Each payload is inserted into a transfer unit 121 of the stream of transfer units 120. Accordingly, each transfer unit includes a payload for each stream multiplexed into the channel 111. This is shown here as three payloads 122-124, each associated with one of the input streams 101-103. Accordingly, the stream 120 comprises a string of transfer units 121, each populated with the plurality of payload (122-124) which are transmitted through the virtual channel 111 to the receiver 104. It is also pointed out that each transfer unit includes a schedule cycle marker (SCM) 125 and the unfilled portions of the transfer unit can be occupied by a filler portion 126 comprising a string of dummy symbols that completely fills the transfer unit 121. It is also pointed out that there are circumstances under which the transfer units will have zero payloads comprising only the SCM and dummy symbols. It should be noted that the link rate (i.e., the data packet transfer rate) for each virtual channel of the link can be optimized for the particular data stream resulting in the physical link 106 carrying streams of transfer units for each channel each having an associated link rate (channel bit rate CBR). And each channel 111-112 can also have a bit rate that is different from each other channel. The data payloads 122-124 can take any number of forms such as video, graphic, audio, etc.

Typically, when the source is a video source, the data streams 101-103 can include various video signals that can have any number and type of well-known formats, such as composite video, serial digital, parallel digital, RGB, or consumer digital video. The video signal can be an analog video signal such as would be provided by an analog video source, for example, an analog television, still camera, analog VCR, DVD player, camcorder, laser disk player, TV tuner, set top box (with satellite DSS or cable signal) and the like. Also, the source can also include a digital image source such as for example a digital television (DTV), digital still camera, and the like. The digital video signal can be any number and type of well known digital formats such as, SMPTE 274M-1995 (1920×1080 resolution, progressive or interlaced scan), SMPTE 296M-1997 (1280×720 resolution, progressive scan), as well as standard 480 progressive scan video.

In the case where the source provides an analog image signal, an analog-to-digital converter (A/D) converts an analog voltage or current signal into a discrete series of digitally encoded numbers (signal) forming in the process an appropriate digital image data word suitable for digital processing. Any of a wide variety of A/D converters can be used. By way of example, other A/D converters include, for example those manufactured by: Philips, Texas Instrument, Analog Devices, Brooktree, and others.

In implementations where at least one of the source streams 101-103 comprise an analog type signal, an analog to digital converter (not shown) included in or coupled to the transmitter 102 will digitize the analog data into a digital data stream which is then packetized into appropriately sized payloads and then inserted into a transfer unit 121 which will be transmitted to the receiver 104 by way of the virtual link 111. The receiver 104 will then extract the payloads and reconstitute the data stream 101-103 by appropriately recombining the payloads 122-124 into their original format. It should be noted that the link rate is independent of the native stream rates. The only requirement is that the link bandwidth of the physical link 106 be higher than the aggregate bandwidth of data stream(s) to be transmitted. In particular, that the channel bit rate be higher than the native stream bit rate.

In this way, the interface 100 provides a scaleable medium for the transport of not only video and graphics data, but also audio and other application data. In particular, the present invention enables a link to transmit more than one source stream per virtual channel and therefore many source streams using the same link. This is extremely valuable as prior art systems were limited to no more than four source streams for each link. Implementations of the invention can support hot-plug event detection and automatic setting of the virtual links to their optimum transmission rates. Typically, this means that the linking unit 106 includes a hot plug line. The invention provides for a low pin count, purely digital display interconnect for all displays suitable for multiple platforms. Such platforms include host to display, laptop/all-in-one as well as HDTV and other consumer electronics applications. In addition to providing video and graphics data, display timing information can be embedded in the digital stream providing essentially perfect and instant display alignment, obviating the need for features like “Auto-Adjust” and the like. The transfer unit based nature of the inventive interface provides scalability to support multiple, digital data streams such as multiple video/graphics streams and audio streams for multimedia applications. In addition, a universal serial bus (USB) transport for peripheral attachment and display control can be provided without the need for additional cabling.

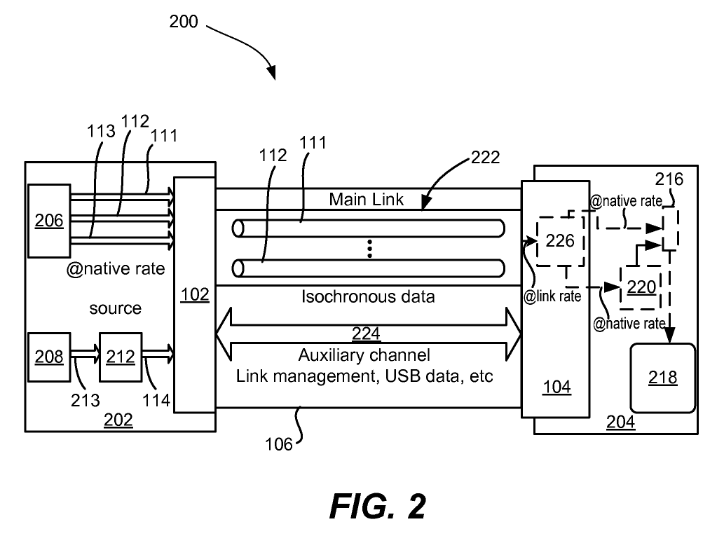

FIG. 2 illustrates a system 200 based upon the system 100 shown in FIG. 1. Here multimedia source 202 is coupled to a multimedia sink 204. For example, any of a number of AV components can be used as either source or sink. The illustration shown here is crafted to illustrate the application of both digital and analog implementations. For example, the source 202 can be a digital image (or digital video source) 206 and/or an analog image (or analog video source) 208. In the case of the digital image source 206, one or more digital data streams (e.g., streams 111, 112, 113 as described with respect to FIG. 1) are provided to the transmitter 102. Additionally, in some embodiments, analog signals can be treated. For example, an analog image 208 or analog data stream 213 is input into an A/D converter unit 212 to generate a corresponding digital data stream 114. The digital data stream 114 is then processed in much the same manner as the digital data streams 111-113 by the transmitter 102. The display unit 204 can be an analog type display or a digital type display or in some cases can process either analog or digital signals provided thereto. Also, the video source 202 can take any number of forms (such as a personal desktop computer, digital or analog TV, set top box, etc.) whereas the video display sink 204 can be any sort of AV sink device, particularly video displays (such as an LCD type display, CRT type display, etc.).

Regardless of the type of video source or video sink, however, the various data streams are digitized (if necessary) and packetized prior to transmission over the physical link 106. Typically, this is accomplished using scheduler circuitry and/or software that is coupled to or forms part of the transmitter. Once packetized into transfer units the data payloads are transmitted using the link 106 (particularly the main link 222). Typically, such a link includes a uni-directional main link 222 for isochronous data streams and a bi-directional auxiliary channel 224 for link setup and other data traffic (such as various link management information, attribute transmission, Universal serial bus (USB) data, etc.) between the video source 202 and the video display 204.

The main link 222 is thereby capable of simultaneously transmitting multiple isochronous data streams (such as multiple video/graphics streams and multi-channel audio streams). As previously described, and as shown here, the main link 222 includes a number of different virtual channels (111-112), each capable of transferring isochronous data streams (such as uncompressed graphics/video and audio data) at multiple gigabits per second (Gbps). From a logical viewpoint, therefore, the main link 222 appears as a single physical pipe and within this single physical pipe, multiple virtual pipes 111, 112 can be established. In this way, logical data streams are not assigned to physical channels rather, but rather data streams can be allotted to the virtual channels.

In the described embodiment, the speed, or transfer rate, of the main link 222 can be adjustable to compensate for link conditions. For example, in one implementation, the speed of the main link 222 can be adjusted in a range approximated by a slowest speed of about 1.0 Gbps to about 2.7 Gbps per channel. The various applications and data transmission attributes of such channels are describes in the previously referenced U.S. patent application Ser. No. 10/909,085 of Kobayashi.

In one embodiment, data sent to the interface arrives at the transmitter 102 at its native rate. In one format, a time-base recovery (TBR) unit 226 within the receiver 104 regenerates the stream's original native rate using time stamps embedded in the main link data packets, if necessary. It should be noted, however, that for appropriately configured digital display devices, units 216 and 226 are not needed as time base can be recovered without resort to a TBR unit. For example, the display data can be sent to the display driver electronics 218 at the link character clock rate, thereby greatly reducing the number of channels required with a commensurate reduction in complexity and cost for the display. However, for an analog display the digital data will still have to be converted back to analog format by digital to analog convertor 220. Many methods for synchronizing channel/link rates and pixel rates of the source data are known to those of ordinary skill, for example as shown in the previously referenced U.S. patent application Ser. No. 10/909,085 of Kobayashi. A few particularly advantageous approaches will be discussed else wherein this patent.

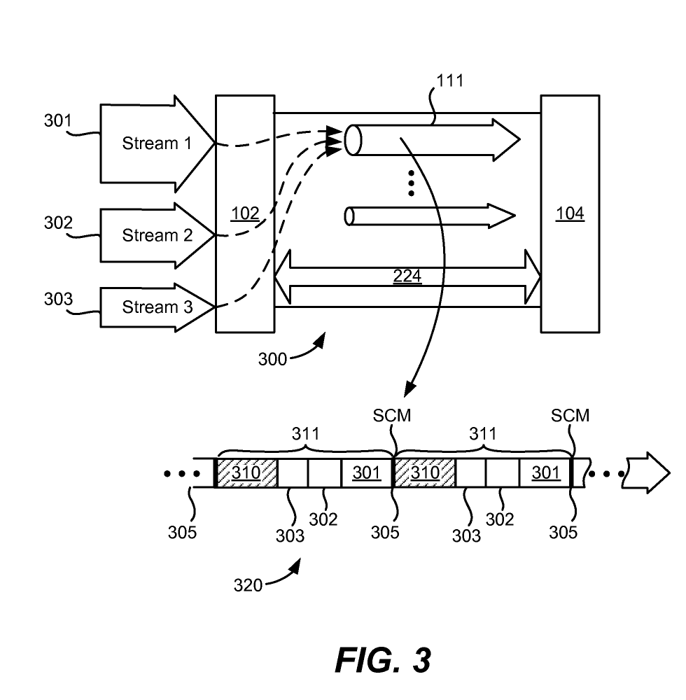

One of the advantages of the inventive interface is the ability to multiplex different data streams each of which can be different formats as well as have different blanking cycles. In accordance with an embodiment of the invention, certain aspects of the invention will now be described. In the embodiment described schematically in FIG. 3 three source streams 301, 302, & 303 are provided to a multiplexer of the transmitter. The source streams can be any type of multimedia data, but for descriptive purposes we describe a set of three uncompressed video streams. Although described here with respect to three source streams, the principles can be applied to many more such streams. These streams 301-303 are received into a buffer of the transmitter 102, the streams are then multiplexed and scheduled in the transmitter and transmitted through a channel (e.g., 111) of the main link 222 of the linking unit. Additionally, time base recovery is easily accomplished without the need for a clock line or signal. Accordingly, the link embodiments of the invention do not require a clock line.

The source data can be packaged in a method as follows. The source data can be a set of video streams (e.g., 301-303) formatted, for example, as an uncompressed video stream encoded in an ANSI 8b/10b format. Using such a format, each symbol is defined by 10 bits. The symbols are defined by the 8b/10b format (12 control symbols and 256 data symbols). A link 106 is coupled to the transmitter 102. A channel 111 of the link has been set at a channel link bit rate of 2.70 Gbs. At ten bits per symbol, this means the channel can transmit 270 mega-symbols per second (M-symbols/s).

Returning to a description of the data streams, in this example each video stream comprises an uncompressed raster video stream. Each stream having a native pixel rate unrelated to that of the other streams. For example, Stream 1 (301) has a symbol rate of 100 M-symbols/s, Stream 2 (302) has symbol rate of 31.25 M-symbols/s, and Stream 3 (303) has symbol rate of 25 M-symbols/s. In accord with this embodiment, each channel carries a stream of fixed size transfer units at the link rate of the channel. Here the transfer units are set at 64 symbols per transfer unit. The invention multiplexes the streams so that each transfer unit carries a payload associated with each stream assigned to a channel. This is a substantial difference from the cited art which is limited to a single stream per channel. This improvement substantially increases data transmission efficiency.

Each payload is allotted a number of symbols per transfer unit in accordance with the following relation. For a particular payload (i) an associated payload size PSᵢ is related to a transfer unit size TUS (here 64 symbols), a channel symbol rate CSR (which characterizes the symbol rate for the channel in question) and a symbol rate of each stream i (SSRᵢ) by way of the following relationship:

PSᵢ=((number of symbols in each transfer unit)*(SSRᵢ/CSR))

Each payload size is rounded upward. Accordingly, in this example, each transfer unit (TU) comprises 64 symbols. Thus the payloads are allotted to the TU as follows. Stream 1 (100 M-symbols/s) is allotted 24 link symbols, Stream 2 (31.25 M-symbols/s), 8 symbols, and Stream 3 (25 M-symbols/s), 6 symbols. Each transfer unit includes a single control symbol for a Schedule Cycle Marker (SCM) to delineate each TU from the next TU in the stream. In the depicted example, the payloads and SCM occupy 1+24+8+6=39 symbols. Thus, there are 3 payload spaces, an SCM, and a filler portion of 25 symbols in size. Typically, the filler portion will be populated with “dummy” symbols that contain no data. Thus, as shown, each transfer unit 311 includes three payload spaces 301-303, an SCM 305, and a filler portion 310 in each transfer unit 310. It is important not to oversubscribe the transfer units (i.e., allocate streams to the point where the payloads exceed the transfer unit size, here 64 symbols). There is no spacing or header to demarcate the payloads of a transfer unit. Each stream of transfer units is sized and configured at the transmitter 102, the attribute information which describes the stream transfer units 320 is transmitted to the receiver 104 which can then receive the transfer units and decode them and reconstitute the source streams.

The system 300 includes a stream source multiplexer included in the transmitter 102 used to combine the source streams 301-303 to form each transfer unit 311 which is then transmitted as a multiplexed data stream 320 having multiple data streams transmitted through a single channel 111. At the receiving end, the receiver 104 includes a link layer de-multiplexer that splits the multiplexed data stream 320 into its constituent data streams based on the attribute information previously forwarded to the receiver 104. Such information includes transfer unit architecture (e.g., payload size and position in the TU, associated stream IDs (SIDs), etc.). This approach is extremely advantageous because the packet header (SCM) is at about the smallest possible size, which results in the very high link efficiency. As already explained, the reason the packet header can be so small is that the packet attributes are communicated via the auxiliary channel 224 prior to the transmission of the packets over main link. In other embodiments, the packet attributes can be sent over the main link with no decrease in efficiencies as explained in the paragraphs below.

Generally speaking, this transfer unit scheme is effective when the transfer units carry uncompressed video data, since an uncompressed video data streams have data idle periods corresponding to the video-blanking period. The approach set forth here enables data streams with absolutely no relation to each other to be transmitted using the same main link and the same virtual channel.

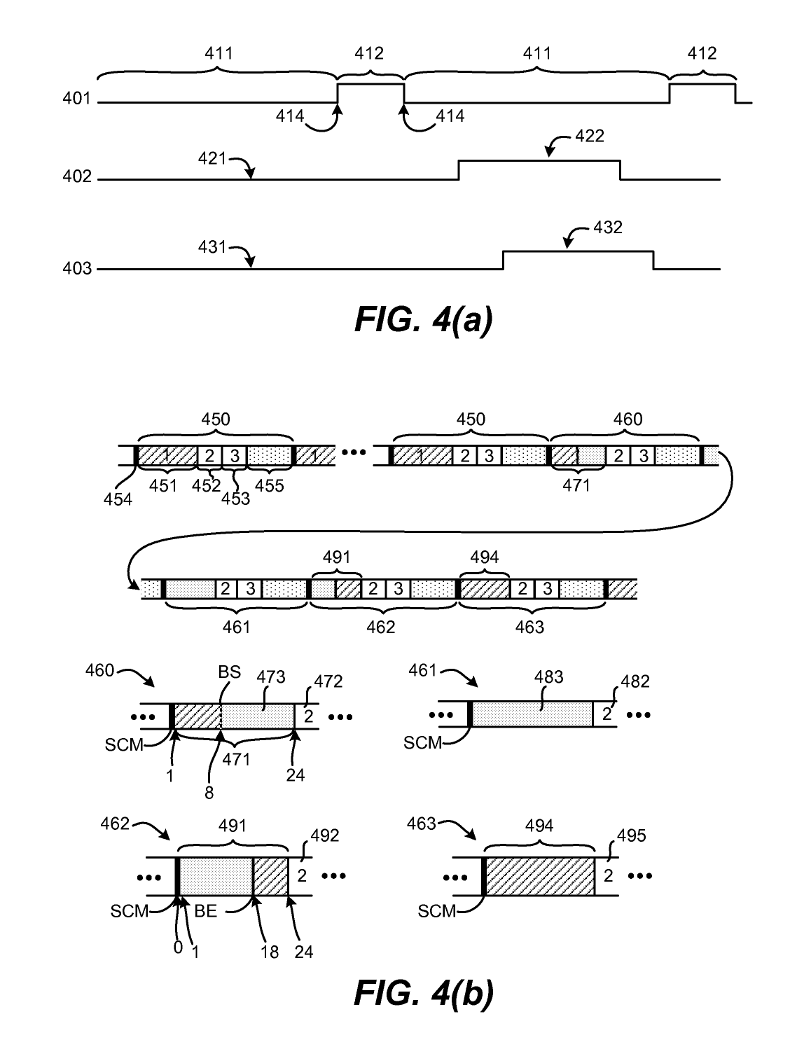

FIG. 4(a) illustrates a transfer unit stream 400 including 3 different source data streams 401-403 each comprising a raster video signal having a different blanking cycle and no synchronization between streams. Stream 401 represents a first stream (Stream 1) having a first symbol rate and having a blanking cycle indicated by alternating active periods 411 where video data is sent and blanking periods 412 where no video data is sent. Each blanking period 412 has a blanking start (BS) 413 and an associated blanking end (BE) 414 for each blanking period.

Additionally, Stream 402 represents a second stream (Stream 2) on the same relative time scale having a second symbol rate which may or may not be at the same rate as the first stream 401. Continuing, Stream 2 has its own a blanking cycle indicated by alternating active periods 421 and blanking periods 422. The blanking periods can be in synchronization with that of Stream 1 (or other data streams) but are not required to be so. In this depiction there is no synchronization with Stream 1. Ordinarily this disunity of stream synchronization causes a number of problems, but embodiments of the invention neatly avoid the prior art problems as will be explained elsewhere in this patent. As further shown, a third stream 403 (Stream 3) on the same relative time scale with a third symbol rate which may or may not be at the same rate as some of the other streams 401 or 402. As shown here the Stream 3 blanking cycle indicated is by alternating active periods 431 and blanking periods 432. As before, the blanking periods can be in synchronization with that other data streams, but are not required to be so. In this depiction there is no synchronization.

Referring now to FIG. 4(b), an embodiment of transfer unit data stream 400 configured for transmission though a link using a single virtual channel is described. In accord with a methodology, such as that described above, payload sizes are determined for data packets from each stream 401-403. Using the example above, the payload sizes can be 24 symbols, 8 symbols, 6 symbols respectively associated with Stream 1 (401), Stream 2 (402), and Stream 3 (403). Each transfer unit 450 includes a payload space for each payload. Here, each transfer unit 450 is configured as comprising 64 symbols. Thus, each transfer unit includes a payload space 451 for stream 1, a payload space 452 for stream 2, a payload space 453 for stream 3, a SCM symbol 454 and the balance of the transfer unit having a filler portion 455. Here, the payload space 451 is filled with a payload comprising a data packet comprising 24 symbols from the first data stream 401, payload space 452 is filled with a payload comprising a data packet comprising 8 symbols from the second data stream 402, and payload space 453 is filled with a payload comprising a data packet comprising 6 symbols from the first data stream 403. The remaining [64−(1+24+8+6)=25] symbols comprise non-video data or dummy symbols. Thus, each transfer unit is always filled and the channel is fed a continuous stream of transfer units.

With continued reference to FIG. 4(b), Stream 1 (401) continues to send video data symbols during the active period 411, but at the beginning of the blanking period 413 non-video data dummy (or null) symbols are introduced into the payload for Stream 1. This blanking start may begin at any point in the payload packet 451. Thus, from that point forward until the end of the blanking period 414 the payloads will contain a string of non-video data dummy symbols. Each of these points is marked in the associated payload of the respective transfer unit with an appropriate control symbol. For example, a BS control symbol indicates the beginning of the blanking portion of the blanking cycle. Also, a BE control symbol indicates the end of the blanking portion of the blanking cycle (i.e., the start of the active cycle). Thus, once a BE symbol is reached it restarts the active portion of the AV blanking cycle and the payloads are again full of video data symbols.

This can be illustrated with reference to transfer elements 450 and 460-464. Which are taken from various points in a typical stream 400. TU 450 is a standard transfer unit for an active portion of Stream 1 (401). The entire payload in payload space 451 is filled with valid video data symbols from data stream 401. For example 24 data symbols. The payload streams for the other streams will be filled in accord with their own data patterns but the concentration will be on a discussion of the first stream. A similar approach applies independently to all other data streams in each transfer unit. When the data stream 401 reaches the blanking start 413 portion of the blanking cycle non-data symbols are all that are provided by the source data stream. The prior art has many different approaches for dealing with this blanking period. However, the present invention neatly and simply addresses the issue as follows.

When the blanking start occurs in the source stream, the scheduler places the BS symbol in the associated portion of the payload packet. The following symbols after the BS marker are simply non-data dummy symbols that fill the assigned portions of the data packets until such time as the actual data starts again. Such is illustrated in the expanded view of a portion of transfer unit 460. The first payload portion 471 is shown here beginning after the SCM symbol and ending as the second payload 472 begins.

Video data symbols (symbols at positions 1-7) are inserted after the SCM (symbol 0), at which point a BS symbol (at symbol 8), corresponding for example to 413 of 401, is introduced into the transfer unit. The symbols after the BS marker (symbols 9-24) are non-data dummy symbols 473 which fill the remainder of the payload 471.

Transfer unit 461 illustrates one of a number of transfer units that follow in the stream after unit 461. In these units, the payload portion allotted for Stream 1 is now filled with non-data dummy symbols 483 which end as the second payload 482 begins.

As shown with respect to transfer unit 462 when the source stream reaches the end of the blanking portion (such as at 414 of 401), the scheduler places a BE symbol in the associated portion of the payload packet. The portions of the payload that follow after the BE marker are valid video data symbols (non-dummy) from the active period of the blanking cycle. Such is illustrated in the expanded view of a portion of transfer unit 462. The first payload portion 491, as before, begins after the SCM symbol and ends as the second payload 492 begins. The string of dummy symbols (symbols at positions 1-17) are inserted after the SCM (symbol 0), and come to an end at the BE symbol (at symbol 18), corresponding for example to 414 of 401, is introduced into the transfer unit. The symbols after the BE marker (symbols 19-24) begin the string of video data symbols transmitted from the source Stream 1 401 in the renewed active period and which fill the remainder of the payload 491.

Transfer unit 463 illustrates one of a number of transfer units that follow in the stream after unit 462. In these units, the payload portion 494 allotted for Stream 1 is now filled entirely with video data symbols from stream 1 which end as the second payload 495 begins. As such the transfer unit is very similar to that of 450 depicted previously.

Another advantageous attribute of embodiments of the invention is the flexibility to which the dummy portions (e.g., 473, 483, etc,) of the streams can be put.

Another advantageous attribute of embodiments of the invention is the ease with which streams can be dynamically added or deleted from the TU stream of a channel.

Firstly, an embodiment of the invention configures the scheduler cycle time in accord with the following scheme. For the data stream in each virtual channel a Schedule Cycle Marker (SCM) is inserted every 64 symbols to delineate a schedule cycle marker. After 128 schedule cycles (8192 symbols) a set of symbols that indicate a line boundary marker are inserted. Additionally, once in every 512 lines a set of symbols that indicate a frame boundary marker are inserted.

A few examples of such markers are illustrated. To demarcate a link line (without copy protection), a series of SCM's are replaced with the following control symbols arranged once every 128 cycle times to indicate a line marker: BF+SR+SR+BF.

To demarcate a link line (with copy protection), a series of SCM's are replaced with the following control symbols arranged once every 128 cycle times to indicate a line marker: BF+CP+CP+BF.

To demarcate a frame (without copy protection), a series of SCM's are replaced with the following control symbols arranged once every 512 link lines to indicate a frame marker: SR+BF+BF+SR.

To demarcate a frame (with copy protection), a series of SCM's are replaced with the following control symbols arranged once every 512 link lines to indicate a frame marker: SR+CP+CP+SR.

Also, instead of being directly adjacent to each other, adjacent control symbols are 64 symbols apart.

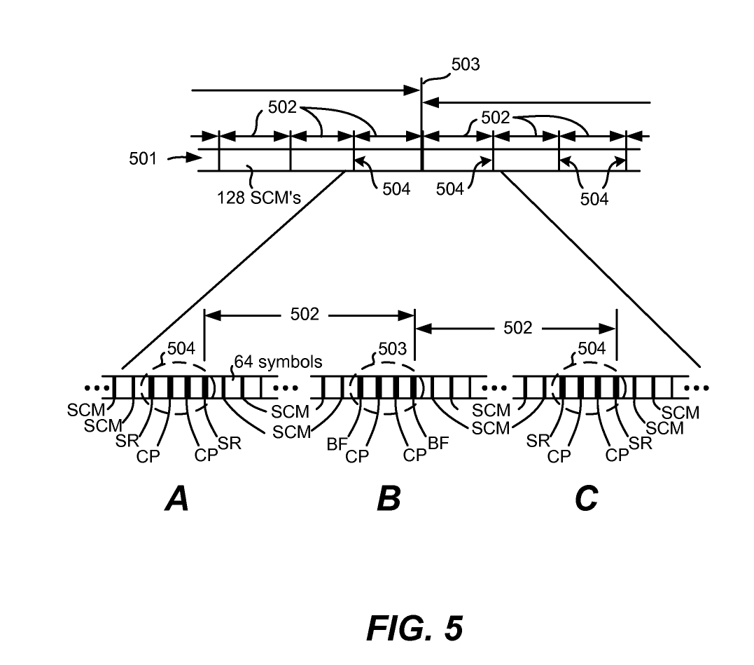

FIG. 5 illustrates an embodiment of transfer unit stream 501 having line and frame markers as indicated above. Only a small portion of a very long stream is depicted. A series of link lines 502 are configured such that they occur once every 128 SCM's (8192 symbols). Also, a link frame boundary 503 as shown. Such frame boundaries are spaced 502 every 512 line boundary markers. A portion A of the data stream 501 shows the SCM's which occur every 64 symbols and also shows the link line boundary 504 having a series of link line boundary symbols each separated by 64 symbols. For the instant embodiment, the link line boundary pertains to a copy protected HD video signal and therefore includes copy protection symbols (CP's) and a pair of SR symbols to define the line boundary. After another 128 SCM's there is another link line boundary. This shown by portion B. However, in this case, the boundary is 512 lines from the last frame boundary (not shown in this view) and so therefore defines a frame boundary 503. As with the line boundary illustrated in A, this portion B of the data stream 501 shows the SCM's which occur every 64 symbols and also shows the link frame boundary 503 having a series of link line boundary symbols also separated by 64 symbols. For the instant embodiment, the frame line boundary also pertains to the copy protected HD video signal and therefore includes copy protection symbols (CP's) and a pair of BF symbols to define the frame boundary. And finally, in portion C another link line boundary 504 is depicted as 128 SCM's (502) from the frame boundary 503. This line boundary is similar to that depicted in portion A. Copy protected HD video signal including a pair of copy protection symbols (CP's) and a pair of SR symbols to define the line boundary. For non-copy protected signal the above described frame and line markers would be used instead.

The framing and line boundary structures described above are just one possible implementation of the invention. This framing scheme has many advantages as will be discussed in the following paragraphs.

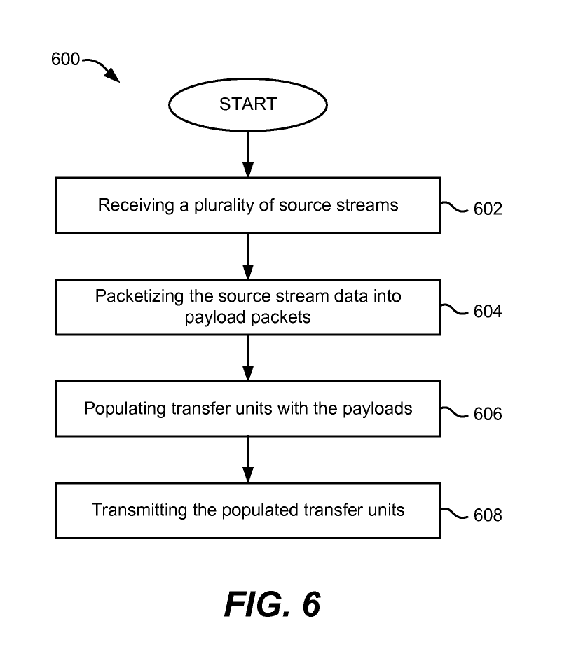

An example is provided to illustrate an embodiment of the process. FIG. 6 is a flow diagram 600 illustrating one embodiment of stream addition in accordance with the present invention. A multimedia network including at least one multimedia source device and at least one multimedia sink device are provided. A transmitter is part of the source or is coupled with the source. Also, a receiver is part of the sink or is coupled with the sink. The receiver and the transmitter are coupled using a data link of the types described herein. In the instant example, the network is already configured and is sending video data traffic from the transmitter to the receiver in accord with one of the schemes previously disclosed above. In this described data transmission method, the network has already determined the bandwidth of the virtual channel and determined the size of the payloads allotted to each source stream. Thus, a transmission scheduler is configured to packetize each data stream into appropriately sized payload packets. The receiver has also received all of the necessary attribute information required to decode the transfer units at the receive end.

In this environment, a plurality of source streams are received by the transmitter (Step 602). In one example, the streams are received by a packet scheduler coupled with or part of the transmitter. The data of each of the streams is packetized into payloads of a predetermined size associated with the symbol rate of the source streams (Step 604). Again, in one example, a portion of the transmitter or the scheduler can perform this packetizing. Transfer units are then populated with the payloads (Step 606). As discussed above, each transfer unit includes a SCM symbol delineating it from other transfer units in the stream. A payload from each source stream is inserted into the designated payload space of each transfer unit. Thus, payloads from each stream are loaded in sequence one a after another into a stream of transfer units. As also indicated, portions of the transfer units not containing payload data are filled with dummy symbols. As the transfer units are populated they are transmitted through the designated virtual channel to the receiver (Step 608). At the receiver the payloads can be stripped away from the transfer units and recombined into their intended source streams at the original native rate for use at the receive end using the attribute information. For example, the data can be displayed on a video display.

The above method defines one embodiment of data transmission in accordance with the principles of the invention. As indicated above, one attribute of the invention that has considerable utility is the ease at which streams can be added and deleted from the channel.

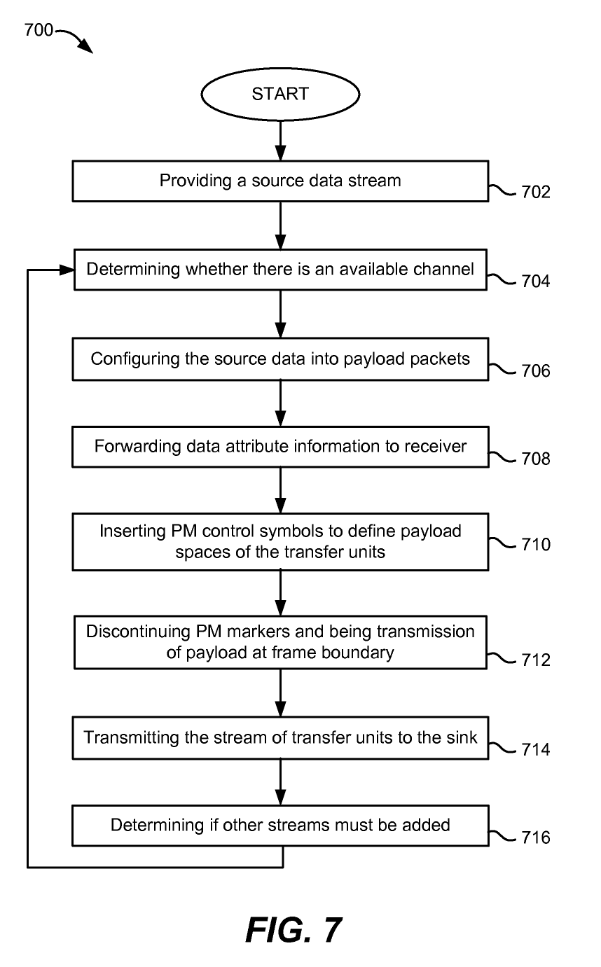

An example is provided to illustrate a process for adding a data source stream to a stream of transfer units. FIG. 7 is a flow diagram 700 illustrating one embodiment of stream addition in accordance with the present invention. A multimedia network including at least one multimedia source device and at least one multimedia sink device are provided. A transmitter can, for example, be part of the source or be coupled with the source. Also, a receiver can be a part of the sink or be coupled with the sink. The receiver and the transmitter are coupled using a data link of the types described herein. In the instant example, the network is configured with no data streams being transmitted.

A networked source seeks to send multimedia data (e.g. audio video data) to a source of the network. This begins by the transmitter having a source data stream and that needs transmission to a sink device on the network (Step 702). The system becomes aware of such a source by, for example, a “hot plug” event for a source device or by a source device beginning to transmit a data stream. A determination is made regarding an available means of transmission (Step 704). This will involve the transmitter determining if there are any virtual channels available for data transport. If it is determined that there is an available transport channel, a determination of channel data bit rate is made and also of the pixel rate of the source signal. If the pixel rate is less than the available bandwidth of the channel the channel is available for use.

Once an available channel is identified, the data payloads are configured for the source stream such that they can be input into the transfer units of a data stream transported by the channel (Step 706). For example, if the symbol rate of the channel is 270M-symbols/s and the symbol rate of the source stream is 135M-symbols/s and each transfer unit is 64 symbols, then the size of the data payload for the source stream is 32 symbols. Currently, the initial pattern in the transfer units of the stream is 64 dummy symbols which carry no data. Typically such symbols are scrambled. At this point, the transmitter understands how the data is to be transmitted and where it is to be transmitted to. This information, along with a the final destination of the payload, as well as any other necessary data attributes is configured into an attribute packet which is forwarded to the receiver (Step 708) which can then use the attribute data to decode the received transfer units or forward them to the desired destination. Typically, the receiver will return an acknowledge message confirming the receipt of the attribute information at the receiver.

Also, up to this point the transfer units are empty containing only dummy symbols. Once the data is configured and the payload size determined (see Step 706) then the receiver alters the contents of the transfer unit. A set of payload marker control symbols (PM) are inserted into the transfer unit to mark the position and size of the payload space into which payload packets will be inserted (Step 710). Typically, the PM markers are introduced at the beginning of the payload space and at the end of the payload space. Thus, at least two payload markers are used to mark the bounds of the payload space. Thus, every transfer unit sent has a set PM symbols configured to mark the payload space. This stream of PM containing transfer units continues until the transfer unit stream reaches a frame boundary (e.g., 503 of FIG. 5).

Once the number of transfer units transmitted reaches a frame boundary, the PM symbols are discontinued and payload packets (of a size defined in Step 706) are used to populate the payload space of each transfer unit (Step 712). Thus, a stream of populated transfer units is generated. This stream of transfer units is transmitted to the sink (Step 714). This can continue until the connection is lost or intentionally deleted. Additionally, once a stream has been added, other streams can be added using much the same methodology (Step 716). If no further streams need to be added, the process simply continues to send transfer units as configured until such time as the source data streams are deleted or interrupted. Once the sequence is completed, additional streams can be added until, in the extreme case, the entire transfer unit is filled with payload. But, each stream is typically added in its entirety before another stream is added.

An example is provided to illustrate a process for adding another data source stream to a virtual channel already having at least one stream. FIG. 7 can be used to further illustrate the process. When a second (or more) source stream is to be added a determination is made regarding the available means of transmission (Step 704). For example, the transmitter determines which virtual channels have are available for data transport. If it is determined that there is an available transport channel, the bit rate of the source stream is determined. This is compared to the available channel bandwidth. For example, if a channel has total bandwidth of 2.56 Gbps and a first stream having a bit rate of 1.28 Gbps, the available bandwidth is 1.28 Gbps. So, a source having a bit rate of less than 1.28 Gbps will not oversubscribe the channel and therefore can be added. Then, as before, the new source is configure so that new payloads can be input into the transfer units of a data stream transported by the channel (Step 706). In one example, a transfer unit comprises 64 symbols and the symbol rate of the channel is 270M-symbols/s. Where the symbol rate of the first source stream is 135M-symbols/s the size of the data payload for the first source stream is 32 symbols. This leaves 31 symbols for new source streams (the SCM occupies on the 32 remaining symbols). Where the symbol rate of the second source stream is 90M-symbols/s the size of the data payload for the second source stream is 22 symbols. Thus, the second payload is 22 symbols and the transfer unit carries two payloads and an SCM symbol for a total of 55 leaving 9 as dummy symbols. Again, such symbols are typically scrambled. Once the size of the payload is determined, the position in the transfer unit is determined. Typically, the next available space is populated with the new payload. Thus, in the present example, the SCM is at symbol 0, the first payload (32 bits) occupies symbols 1-32, the second payload (22 bits) occupies symbols 33-54, with the final nine bits occupying symbols 55-63. At this point, the transmitter is aware of the data structure of the transfer unit and where it is to be transmitted to. This information, along with a number of other data attributes is forwarded to the receiver (Step 708) which can then use the new attribute information to decode the received transfer units. As before the receiver typically returns an acknowledge message.

A new set of payload marker control symbols (PM) are inserted into the transfer unit to mark the position and size of the payload space into which payload packets will be inserted (Step 710). Typically, the PM markers are introduced at the beginning of the payload space and at the end of the payload space. Thus, at least two payload markers are used to mark the bounds of the payload space. Here one marker will be inserted at symbol 33 and another at symbol 54. Thus, every transfer unit is configured with PM symbols to mark the payload space enabling the receiver to track, mark, and confirm the location of the added payload. As before, the stream of PM containing transfer units is transmitted until a frame boundary (e.g., 503 of FIG. 5) is reached. As before, at the frame boundary the PM symbols are discontinued and real data (the payload packets) is inserted (Step 712). Thus, the stream of transfer units is altered to accommodate the new stream which is then transmitted to the sink (Step 714). This can continue until the connection is lost or intentionally deleted. Additionally, once a stream has been added, further streams can be added using much the same methodology as described in the previously disclosed processes (Step 716).

Another advantage of the invention is that it can dynamically delete streams as easily as it can dynamically add them. The following approach can be used to illustrate some aspects of this feature.

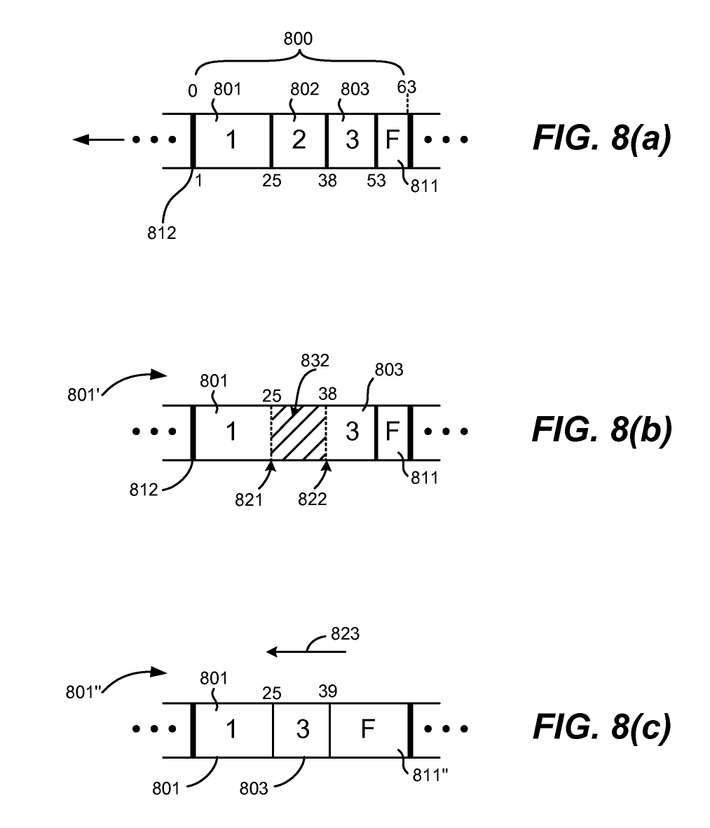

FIGS. 8(a)-8(c) illustrate a transfer unit as it is processed through a dynamic stream deletion. With reference to FIGS. 8(a)-8(c) a generalized description of the process is illustrated. In FIG. 8(a), an initial transfer unit 800 is shown with three payloads 801-804 (and their approximate demarcation symbols), a filler portion 811 filled with dummy symbols, and an SCM symbol 812. In the present example, the first payload 801 associated with the first source stream comprises 23 symbols (e.g., extending from symbols 1-24), the second payload 802 associated with the second source stream comprises 14 symbols (e.g., extending from symbols 25-38), the third payload 803 associated with the third source stream comprises 15 symbols (e.g., extending from symbols 39-53), and the filler 811 comprises the remaining 10 symbols (e.g., extending from symbol 54-64) which are a set of dummy symbols F.

The process for deleting a stream generally involves removing the payload for the stream to be deleted and then adjusting the transfer unit to accommodate the changes. Accordingly, when stream 2 is to be deleted, the payloads 802 associated with that stream are no longer inserted into the transfer units. This is shown in the space 832 of transfer unit 801′ of FIG. 8(b). Accordingly, the first payload 801 remains in the transfer unit (e.g., extending from symbols 1-24), the second payload 802 is removed leaving a gap 832 of 14 symbols (e.g., symbols 25-38), the third payload 803 also remains in its former position (15 symbols extending from symbols 39-53). The filler 811 also remains the same occupying symbols 54-64. At this point the deleted stream generally has PM symbols inserted to demarcate where the deleted stream was. In the instant case such markers 821, 822 can be inserted on either end of the stream 2 payload space (e.g. at symbol positions 25 and 38).

Once the stream is deleted and the remaining streams are concatenated to a contiguous line of payloads and the filler portion is increased in size to accommodate the reduction in payload spaces. This is depicted in FIG. 8(c) which shows the new configuration for the transfer unit 801″. In this transfer unit a concatenation (represented by arrow 823) of the payloads 801 and 803 is effected and the size of the filler F″ is now expanded. Accordingly, the first payload 801 remains in the transfer unit (e.g., extending from symbols 1-24), the third payload 803 is moved adjacent to the first payload (15 symbols now extending from symbols 25-39). The filler 811 is expanded to occupy symbols 40-64. Thus, the new stream of transfer units is configured.

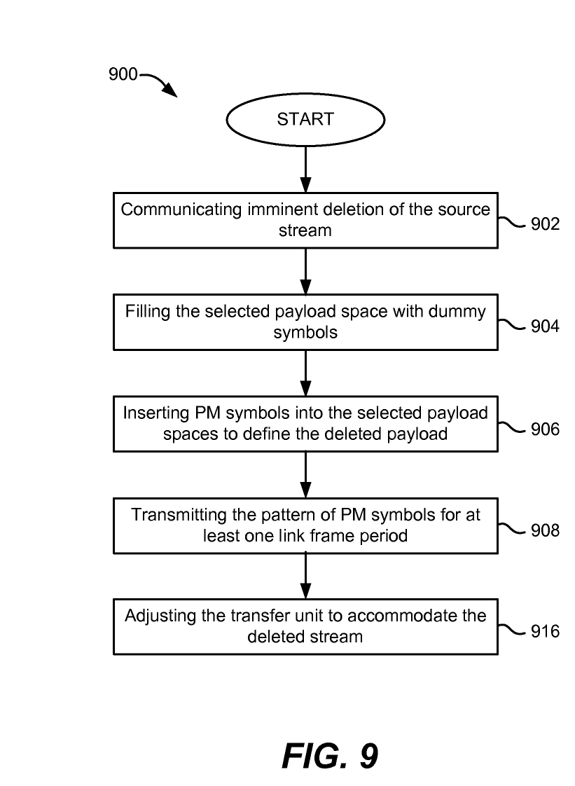

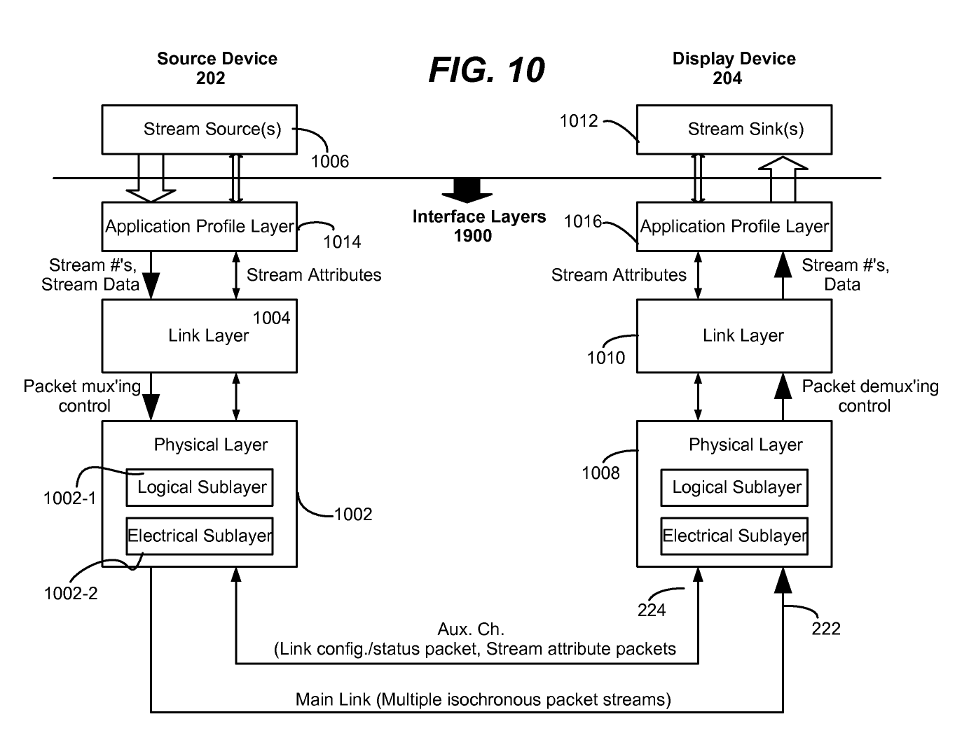

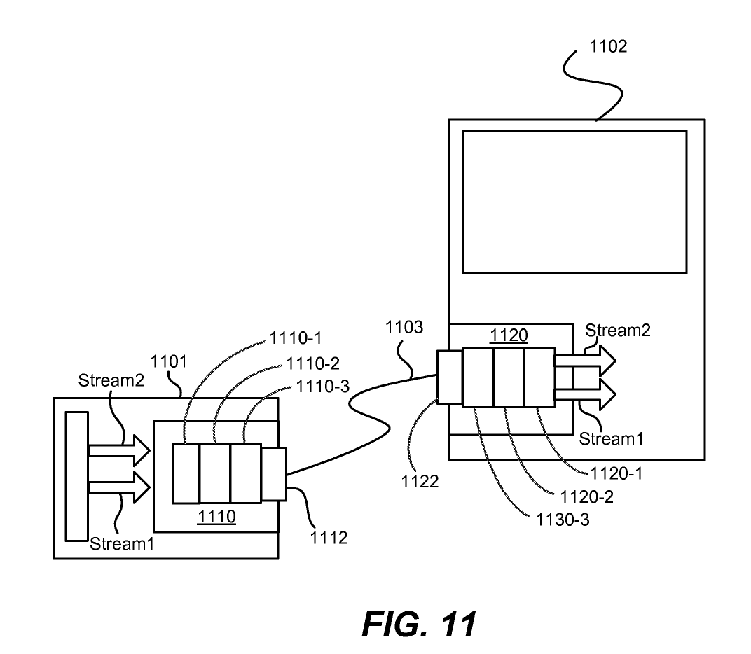

In a further elaboration a discussion of flow diagram FIG. 9 illustrates an embodiment for deleting a data source stream to a stream of transfer units. A multimedia network configured as described above (e.g., with respect to the methods of stream addition in FIG. 7 is configured with at least one data stream being transmitted through the link.

The process begins when a networked source seeks to terminate a source data stream or alternatively loses a connection with a source stream. Such a network is transmitting a stream of transfer units containing payload packages associated with various streams. FIG. 8(a) illustrates one example of such transfer unit carrying three streams through a virtual channel of a link as disclosed herein. The source communicates a message announcing imminent deletion of the source stream (Step 902). Such a message will include notification of the deletion of the stream and the position in the transfer unit where the deletion will occur as well as notification of any changes to the position in the transfer unit of other streams that is caused by the deletion. The system becomes aware of such impending deletion by, for example, a message sent by the sources (e.g., using the auxiliary line or in the blanking portion of a main link data stream) or when the source is disconnected or the signal is lost and data is no longer being sent. At this point, the transmitter begins to pack the payload space formerly assigned to the source stream (and now being terminated) with dummy symbols (also referred to herein as stuffing symbols) (Step 904). For example, in the case illustrated in FIGS. 8(a)-8(c), stream 2 is being deleted. Thus, once the transmitter is aware of the imminent termination of stream 2 (or when it stops receiving multimedia data from stream 2) it begins populating the payload space 832 with dummy symbols. Then PM symbols are placed in the space 832 to mark the size and location of the payload spaces for the stream to be deleted (Step 906). For example, PM symbols 821, 822 are inserted to demarcate space 832 by being inserted on either end of the stream 2 payload space at symbol positions 25 and 38. This pattern of PM symbols is transmitted for at least one link frame period (Step 908). Then at a link frame boundary, the transfer unit is adjusted to accommodate the deleted stream (Step 910). Accordingly, three actions occur. The symbols that populate space 832 (the PM's and dummy symbols) are terminated. The remaining streams in the transfer unit are concatenated (See, FIG. 8(c)) to make a continuous pattern of payloads that place the remaining payloads adjacent to one another. And the dummy portion 811″ is expanded to contain more dummy symbols F″ to fill out the transfer unit. Once the sequence is completed and the stream is deleted, the process can be repeated for each additional stream to be deleted, until, in the extreme case, all streams are deleted. The new transfer units are transmitted without the deleted stream.

The inventors note that some embodiments of the invention utilize a training set up portion to validate and establish a stable link. Such a process is disclosed in detail in the U.S. patent application Ser. No. 10/909,085 (Attorney Docket No.: GENSP127), entitled “PACKET BASED STREAM TRANSPORT SCHEDULER AND METHODS OF USE THEREOF” invented by Kobayashi which is already referenced herein.

It should be pointed out that the auxiliary channel 224 and/or the blanking portion of the payload packets carried by the transfer units can carry a wide range of other data. For example, they can also carry main link packet stream descriptions thereby greatly reducing the overhead of packet transmissions on the main link 222. Furthermore, the auxiliary channel 224 can be configured to carry Extended Display Identification Data (EDID) information replacing the Display Data Channel (DDC) found on all monitors (EDID is a VESA standard data format that contains basic information about a monitor and its capabilities, including vendor information, maximum image size, color characteristics, factory pre-set timings, frequency range limits, and character strings for the monitor name and serial number. The information is stored in the display and is used to communicate with the system through the DDC which sites between the monitor and the PC graphics adapter. The system uses this information for configuration purposes, so the monitor and system can work together). In what is referred to as an extended protocol mode, the auxiliary channel can carry both asynchronous and isochronous packets as required to support additional data types such as keyboard, mouse and microphone.

It should also be noted that the relative size of each payload in a transfer unit provides an embedded time stamp in that by counting the number of data symbols for each payload with respect to the total length of the transfer unit (e.g., 64 symbols) provides a stream clock for the data stream associated with the respective payload. Thus, even for a series of payloads from a plurality of source data streams all populating the same transfer unit, the native rate of the source streams can be recovered. For example, in the case illustrated in paragraphs [0033]-[0036] a stream clock Fₛₜᵣₑₐₘ_{_{—}}_{clk} for a particular data stream can be simply recovered by determining the number of data symbols (M) of a payload as compared to the total number of symbols for the transfer unit (T) and associated with the link rate of the channel F_{channel}_{_{—}}_{clk} More particularly, the stream clock Fₛₜᵣₑₐₘ_{_{—}}_{clk} is determined by the following:

Fₛₜᵣₑₐₘ_{_{—}}_{clk}=(M/T)*F_{channel}_{_{—}}_{clk}

where M and P can be measured by the receiver 204.

Table 2 below is a brief summary of the control symbols used in accordance with the principles of the invention as disclosed above.

TABLE 2

| Encoding | Name | Description |
|---|---|---|
| K.28.0 | Schedule Cycle | Inserted in TU's to delineate TU's |
| | Marker (SCM) | |
| K.28.1 | Blanking Start | Demarcates beginning of blanking |
| | (BS) | portion of blanking cycle |
| K.28.2 | Blanking End | Demarcates end of blanking portion |
| | (BE) | |
| K.28.3 | Payload Marker | Demarcates beginning/end of payload |
| | (PM) | position in transfer unit |
| K.28.4 | Copy Protection | Copy protection marker inserted in place |
| | (CP) | of SCM at line/frame boundaries |
| K.28.5 | Line Boundary | Line boundary marker inserted in place |
| | Marker (BF) | of SCM at line boundaries |
| K.28.6 | Frame Boundary | Frame boundary marker inserted in |
| | Marker (SR) | place of SCM at frame boundaries |
| K.28.7 | Null (NUL) | Dummy data inserted in filler portions |
| | | ad other non-data portions of the TU's |
| K.23.7 | | Reserved |
| K.27.7 | | Reserved |
| K.29.7 | | Reserved |
| K.30.7 | | Reserved |

### Source Device Physical Layer

In the described embodiment, the source device physical layer 1002 includes an electrical sub layer 1002-1 and a logical sub layer 1002-2. The electrical sub layer 1002-1 includes all circuitry for interface initialization/operation such as hot plug/unplug detection circuit, drivers/receivers/termination resistors, parallel-to-serial/serial-to-parallel conversions, and spread-spectrum-capable PLL's. The logical sub layer 1002-2 includes circuitry for, packetizing/de-packetizing, data scrambling/de-scrambling, pattern generation for link training, time-base recovery circuits, and data encoding/decoding such as 8B/10B (as specified in ANSI X3.230-1994, clause 11) that provides 256 link data characters and twelve control characters (an example of which is shown as FIG. 11) for the main link 222 and Manchester II for the auxiliary channel 224.

It should be noted that the 8B/10B encoding algorithm is described, for example, in U.S. Pat. No. 4,486,739, which is hereby incorporated by reference. As known by those of skill in the art, the 8B/10B code is a block code that encodes 8-bit data blocks into 10-bit code words for serial transmission. In addition, the 8B/10B transmission code converts a byte wide data stream of random 1s and 0s into a DC balanced stream of 1s and 0s with a maximum run length of 5. Such codes provide sufficient signal transitions to enable reliable clock recovery by a receiver, such as transceiver 104. Moreover, a DC balanced data stream proves to be advantageous for fiber optic and electromagnetic wire connections. The average number of 1s and 0s in the serial stream is be maintained at equal or nearly equal levels. The 8B/10B transmission code constrains the disparity between the number of 1s and 0s to be −2, 0, or 2 across 6 and 4 bit block boundaries. The coding scheme also implements additional codes for signaling, called command codes.

It should be noted that in order to avoid the repetitive bit patterns exhibited by uncompressed display data (and hence, to reduce EMI), data transmitted over main link 222 is first scrambled before 8B/10B encoding. All data except training packets and special characters will be scrambled. The scrambling function is implemented with Linear Feedback Shift Registers (LFSRs). When data encryption is enabled, the initial value of an LFSR seed is dependent on an encryption key set. If it is data scrambling without encryption, the initial value will be fixed.

Since data stream attributes are transmitted over the auxiliary channel 224, the main link packet headers serve as stream identification numbers thereby greatly reducing overhead and maximizing link bandwidth. It should also be noted that neither the main link 222 nor the auxiliary link 224 has separate clock signal lines. In this way, the receivers on main link 222 and auxiliary link 224 sample the data and extract the clock from the incoming data stream. Fast phase locking for any phase lock loop (PLLs) circuit in the receiver electrical sub layer is important for since the auxiliary channel 224 is half-duplex bi-directional and the direction of the traffic changes frequently. Accordingly, the PLL on the auxiliary channel receiver phase locks in as few as 16 data periods thanks to the frequent and uniform signal transitions of Manchester II (MII) code

At link set up time, the data rate of main link 222 is negotiated using the handshake over auxiliary channel 224. During this process, known sets of training packets are sent over the main link 222 at the highest link speed. Success or failure is communicated back to the transmitter 102 via the auxiliary channel 224. If the training fails, main link speed is reduced and training is repeated until successful. In this way, the source physical layer 1002 is made more resistant to cable problems and therefore more suitable for external host to monitor applications. However, unlike conventional display interfaces, the main channel link data rate is decoupled from the pixel clock rate. A link data rate is set so that link bandwidth exceeds the aggregate bandwidth of the transmitted streams.

### Source Device Link Layer

The source link layer 1004 handles the link initialization and management. For example, upon receiving a hot plug detect event generated upon monitor power-up or connection of the monitor cable from the source physical layer 1002, the source device link layer 1004 evaluates the capabilities of the receiver via interchange over the auxiliary channel 224 to determine a maximum main link data rate as determined by a training session, the number of time-base recovery units on the receiver, available buffer size on both ends, availability of USB extensions and then notifies the stream source 1006 of an associated hot plug event. In addition, upon request from the stream source 1006, the source link layer 1004 reads the display capability (EDID or equivalent). During a normal operation, the source link layer 1004 sends the stream attributes to the receiver 104 via the auxiliary channel 224, notifies the stream source 1004 whether the main link 222 has enough resource for handling the requested data streams, notifies the stream source 1004 of link failure events such as sync loss and buffer overflow, and sends MCCS commands submitted by the stream source 1004 to the receiver via the auxiliary channel 224. All communications between the source link layer 1004 and the stream source/sink use the formats defined in the application profile layer 1014.

### Application Profile Layer

### Source and Sink

In general, the Application Profile Layer defines formats with which a stream source (or sink) will interface with the associated link layer. The formats defined by the application profile layer are divided into the following categories, Application independent formats (Link Message for Link Status inquiry) and Application dependent formats (main link data mapping, time-base recovery equation for the receiver, and sink capability/stream attribute messages sub-packet formats, if applicable). The Application Profile Layer supports the following color formats 24-bit RGB, 16-bit RG2565, 18-bit RGB, 30-bit RGB, 256-color RGB (CLUT based), 16-bit, CbCr422, 20-bit YCbCr422, and 24-bit YCbCr444.

For example, the display device application profile layer (APL) 1014 is essentially an application-programming interface (API) describing the format for Stream Source/Sink communication over the main link 222 that includes a presentation format for data sent to or received from the interface 100. Since some aspects of the APL 1014 (such as the power management command format) are baseline monitor functions, they are common to all uses of the interface 100. Whereas other non-baseline monitor functions, such as such as data mapping format and stream attribute format, are unique to an application or a type of isochronous stream that is to be transmitted. Regardless of the application, the stream source 1004 queries the source link layer 1014 to ascertain whether the main link 222 is capable of handling the pending data stream(s) prior to the start any packet stream transmission on the main link 222.

When it is determined that the main link 222 is capable of supporting the pending packet stream(s), the stream source 1006 sends stream attributes to the source link layer 1014 that is then transmitted to the receiver over the auxiliary channel 224. These attributes are the information used by the receiver to identify the packets of a particular stream, to recover the original data from the stream and to format it back to the stream's native data rate. The attributes of the data stream are application dependent.

In those cases where the desired bandwidth is not available on the main link 222, the stream source 1014 may take corrective action by, for example, reducing the image refresh rate or color depth.

### Display Device Physical Layer

The display device physical layer 1016 isolates the display device link layer 1010 and the display device APL 1016 from the signaling technology used for link data transmission/reception. The main link 222 and the auxiliary channel 224 have their own physical layers, each consisting of a logical sub layer and an electrical sub layer that includes the connector specification. For example, the half-duplex, bi-directional auxiliary channel 224 has both a transmitter and a receiver at each end of the link. An auxiliary link transmitter is provided with link characters by a logical sub layer 1008-1 that are then serialized serialized and transmitted to a corresponding auxiliary link receiver. The receiver, in turn, receives serialized link character from the auxiliary link 224 and de-serializes the data at a link character clock rate. It should be noted that the major functions of the source logical sub layers include signal encoding, packetizing, data scrambling (for EMI reduction), and training pattern generation for the transmitter port. While for the receiver port, the major functions of the receiver logical sub layer includes signal decoding, de-packetizing, data de-scrambling, and time-base recovery.

FIG. 11 shows a particular implementation multimedia network in accordance with one embodiment of the invention. A multimedia source device 1101 (e.g., a set top box, DVD player, etc.) is coupled to a multimedia sink device 1102 (e.g., a display device) using a linking unit 1103 of a type described herein. A plurality of source streams Str 1 and Str 2 are input into a processing unit 1104 of the source 1101. The processing unit 1110 includes integrated circuit systems. The processing unit is configured to receive, packetize, schedule and transport multimedia source data to sink devices 1102 connected to the link 1103. In this example, a plurality of streams (here represented by Str1 and Str2) are received by a receive unit 1110-1 of the processing unit 1110. The receive unit 1110-1 communicates the received stream data to a scheduler unit 1110-2 which packetizes the data of the various streams into transfer unit streams with each transfer unit containing payloads associated with selected source streams (i.e., the streams which are to be transmitted using a virtual channel of the linking unit 1103). The processor 1110 also obtains a set of source attribute information associated with the source data streams (and also in some cases the sink devices) and also associated with the transfer units. Such data will enable the decoding of the transfer units. The scheduler unit 1110-2 forwards the stream of transfer units to a transmit unit 1110-3 which is configured to transmit the stream of transfer units to the sink 1102. Also, the attribute information is sent through the link to the sink. Typically, this is accomplished by transmitting the transfer units and/or attribute information through an interface 1112 that couples the source 1101 to the link 1102. It should be noted that the link can be one of many different formats. The invention is particularly suitable to links that can be configured with a main link configurable with one or more virtual channels. Such embodiments can be further extended to links having an auxiliary link. In one example, the link comprises a uni-directional main link and a bi-directional auxiliary link. The invention is also suited well to implementations where the link does not include a clock line. It is to be noted that the components illustrated here are examples only used to illustrate a general operating principle and should not be construed as limiting. The elements shown here can be configured as separate components, some being separated from the source or integral to it. It is contemplated that they can be combined in a number of configurations. For example, the transmit unit 1110-1 and the transmit unit 1110-3 can easily be arranged as a transceiver unit. Such embodiments can include system-on-a-chip embodiments, separate IC systems, software embedded in chip elements embedded firmware, and so on.

The system further includes a sink element 1103 configured to receive the transfer units and source data through the link 1102. Such a sink could be an AV branch device and a number of sink devices. However, most commonly the sink 1103 comprises a display device. The sink 1103 typically includes an interface 1122 that enables coupling with the link 1102 and forms a conduit for receiving data from the link 1102.

The sink also includes a processing unit 1120 configured to receive, de-packetize, reconstruct and, in many cases, display the data contained in the link 1103. In this example, a stream of transfer units is received by a receive unit 1120-1 of the processing unit 1120. The receive unit 1120-1 communicates the received stream data to a scheduler unit 1120-2 which de-packetizes the data of the transfer units using the attribute data already received by the sink. Typically, the attribute information is received by the receive unit from the link (although it is not required to be so). The scheduler unit 1120-2 decodes the transfer units extracting the payload packets and reconstructs the originating source data streams using the data from the payload packets and the attribute information. The reconstructed data streams are forwarded by the scheduler unit 1120-2 to a transmit unit 1120-3 which is configured to transmit the source streams to a display or forward the source stream to some further location. It is to be noted that the function of the transmit unit can be integrated into that of the scheduler. As before, it is to be noted that the components illustrated here are examples only, illustrating a general operating principle and are not intended as limiting. As before, these elements can be configured as separate or integrated components. For example, the transmit unit 1120-1 and the transmit unit 1120-3 can integrated into a transceiver unit.

Although only a few embodiments of the present invention have been described, it should be understood that the present invention may be embodied in many other specific forms without departing from the spirit or the scope of the present invention. The present examples are to be considered as illustrative and not restrictive, and the invention is not to be limited to the details given herein, but may be modified within the scope of the appended claims along with their full scope of equivalents.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

I claim:

1. A method of transmitting multimedia data from a multimedia source device coupled with multimedia sink device using a linking unit configured having at least one data channel for transmitting data at a channel bit rate, the method comprising the operations of:
receiving a plurality of source data streams, each comprising a stream of associated source data packets an associated native stream bit rate;
formatting a stream of transfer units to enable transmission of said plurality of source data streams as a stream of transfer units through a virtual channel of a linking unit such that the plurality of data streams can be transmitted in said channel; and
transmitting the stream of the transfer units, wherein the stream is transmitted using said data channel from the source to the sink at the channel bit rate.

2. The method recited in claim 1 further comprising the operations of:
configuring attribute information concerning the source data streams and the transfer units into a format that enables transmission to a receiver;
transmitting the attribute information to the sink.

3. The method recited in claim 1 further comprising the operations of:
receiving the stream of transfer units at the sink device; and
reconstituting the source data streams at the sink using the source attribute data.

4. The method recited in claim 1 wherein the said operations are performed by a processor.

5. The method recited in claim 1 wherein the said operations are performed by a source device.

6. Computer program product for use in a multimedia network including a multimedia source device coupled with multimedia sink device using a linking unit configured having at least one virtual data channel for transmitting data at a channel bit rate, the product comprising:
computer code instructions for receiving a plurality of source data streams, each having a stream of associated source data packets having an associated native stream bit rate;
computer code instructions for formatting a stream of transfer units such that each transfer unit includes payload data from each of the plurality of source data streams;
computer code for generating attribute information concerning the source data streams and the transfer units;
computer code for transmitting said attribute information to a receiver; and
computer code for transmitting the stream of the transfer units through a virtual data channel of the link between the source to the sink, thereby enabling the transmission of a plurality of source streams using the virtual channel.

7. The computer program product as recited in claim 1 wherein said code instructions are executed by an integrated circuit device.

8. The computer program product recited in claim 1 wherein said code instructions are executed by circuitry of an audio-video source device.

9. An integrated circuit configured for transmitting a plurality of multimedia data streams from a source device to sink device through a linking unit, the integrated circuit including a processor arranged to enable the functions comprising:
receiving a plurality of multi-media source data streams with each stream carrying multi-media data at its own source stream native data rate;
formatting said source data streams into a stream of transfer units for transmission through a virtual channel of the linking unit, such that each transfer unit includes data from each of the plurality of source data streams;
transmitting attribute information concerning the source data streams and the transfer units to the receiver; and
transmitting the stream of the transfer units using the data channel such that the source streams can be transmitted from the source to the sink using one channel.

10. The integrated circuit of claim 9 comprising a plurality of different semiconductor devices configured to perform said functions.

11. The integrated circuit arrangement of claim 9 wherein said plurality of different systems are arranged on a single semiconductor chip.

12. The integrated circuit arrangement of claim 9 wherein,
formatting said source data streams into a stream of transfer units comprises,
configuring data of each source data stream into associated payloads sized in accordance with a relation between said native data rate and a channel bit rate defined by a data transmission rate for the virtual channel of the linking unit; and
configuring a transfer stream for transmitting data over the virtual channel of the data link, each transfer stream comprising a plurality of transfer units each having a predetermined size and including a schedule cycle marker that delineates one transfer unit from the next in the stream, each transfer unit populated with a payload from each source stream and a filler portion that occupies the balance of each transfer unit; and
transmitting attribute information to the receiver includes,
formatting the source attribute data concerning the source streams and the transfer units; and
transmitting source attribute data from source to sink using the linking unit; and
transmitting the stream comprises transmitting the stream of the transfer units from the source to the sink through the virtual channel at the channel bit rate.

13. The integrated circuit arrangement of claim 12 wherein the system is further configured to add and subtract source data stream payloads to the stream of transfer units.

14. The integrated circuit arrangement of claim 12 wherein the system is further configured to encode source stream blanking cycles for each source stream independently into the associated payloads.

15. A computer program product configured for receiving and decoding a stream of transfer units from a virtual channel of a linking unit that couples a source device to sink device, the product configured to execute:
computer code instructions for receiving a stream of transfer units from a virtual channel of a linking unit, wherein the transfer units include payloads from a plurality of original source data streams;
computer code instructions for receiving attribute information concerning the stream of transfer units, thereby enabling the system to remove payloads from the transfer units and reconstitute original source data streams; and
computer code instructions for decoding the transfer units and reconstructing the original source data streams using the attribute information.

16. The program product of claim 15 further including computer code instructions for recovering the data rate of each source data stream in accordance with a relation between a size of said payload and a size of the transfer unit.

17. The program product of claim 15 further including computer code instructions for independently recovering blanking cycle information for each source data stream using information in the payloads associated with each stream.

18. The program product of claim 15 wherein the program is executed using a microprocessor device.

19. The program product of claim 15 wherein the program embedded in a microprocessor device.

20. The program product of claim 15 wherein the program is executed using a multimedia sink device.

21. A method for receiving a stream of transfer units from a virtual channel of a linking unit that couples a source device to sink device, the method configured to reconstruct original source streams, the method comprising:
receiving a stream of transfer units each including payloads from a plurality of source data streams, wherein the stream of transfer units is received from a virtual channel of a linking unit;
receiving attribute information concerning the stream of transfer units; and
decoding the transfer units and reconstructing original source streams using the attribute information.

22. A multimedia source device comprising:
a receive unit arranged to receive a plurality of multimedia source data streams, each comprising a stream of source data packets having an associated native stream rate;
a multi-stream scheduler arranged to schedule data from the plurality of multimedia source data streams for transport through the virtual channel of the linking unit, the scheduler configured to process the plurality of multimedia source data streams by,
generating a stream of transfer units, each transfer unit having a predetermined size and including,
a schedule cycle marker that delineates one transfer unit from the next in the stream of transfer units, and
at least one of a payload space and a filler portion, wherein a payload space is allotted for each source data stream forming part of the transfer unit and is sized in accordance with a ratio of a native stream rate for each source data stream and the channel bit rate and the filler portion comprises the portion of the transfer unit not occupied by the schedule cycle marker and said at least one payload space, generating data configuration attributes concerning the transfer units, forwarding the stream of transfer units and the data configuration attributes to the transmit unit; and
the transmit unit adapted to couple with a linking unit configured to support data transmission using at least one virtual channel of the linking unit arranged to carry data at a channel data bit rate that is a fraction of a link data bit rate associated with the linking unit, the transmit unit arranged to transmit, at the channel data bit rate, the stream of transfer units and said data configuration attributes to a sink.

23. A multimedia source device as recited in claim 22 wherein the scheduler is further configured to perform the operations of,
grouping data of each source data stream into associated payloads of appropriate size; and
populating the payload spaces of each transfer unit with at least one payload or other symbols, wherein said at least one payload is obtained from each of said plurality of multimedia source streams.

24. A multimedia source device as recited in claim 23 wherein the scheduler can be dynamically add or remove multimedia source streams from the stream of transfer units.

25. A multimedia source device as recited in claim 23 wherein the scheduler as part of grouping data of each source data stream into associated payloads configures the payloads so that each of the plurality of source data streams maintains its own blanking cycle wherein said blanking cycle has a blanking portion and an active portion and wherein the blanking cycle of each source stream can be unrelated to a blanking cycle of another source stream.
